(19) United States
(12) Patent Application Publication
(10) Pub. No.: US 2023/0129167 A1
(43) Pub. Date: Apr. 27, 2023

(54) INTERACTIVE DATE SELECTOR FOR FUND DELIVERY DATES

(71) Applicant: TRUIST BANK, Charlotte, NC (US)

(72) Inventors: Earlie Clark, Wake Forest, NC (US); Szu Yu Zoe Chao, Cary, NC (US)

(21) Appl. No.: 17/509,531

(22) Filed: Oct. 25, 2021

(51) Int. Cl. G06Q 20/10; G06Q 20/14

(52) U.S. Cl. CPC G06Q 20/108; G06Q 20/102; G06Q 20/14

(57) ABSTRACT

A server system is disclosed that may include a processing unit and a non-transitory computer-readable memory that may store instructions that are executable by the processing unit to cause the server system to perform various operations. The server system may transmit a command to a mobile computing device to present a date selector for selecting a fund delivery date to a user via a user interface of the mobile computing device. The date selector may include an interactive calendar that includes a month with a plurality of dates. The server system may receive user-selected dates from the user interacting with the user interface. The server system may determine a fund delivery date using the user-selected dates. The server system may transmit the fund delivery date to the mobile computing device for display on the interactive calendar via the user interface.

### TECHNICAL FIELD

The present disclosure relates generally to user interface arrangements for managing or controlling execution of activities, and more particularly, to determining fund delivery dates for a user of a banking institution.

### BACKGROUND

Users of financial institutions, such as banks, may utilize funds stored in the financial institution to be delivered to various merchants. For example, a user may direct the financial institution to withdraw funds from a financial account associated with the user and deliver the funds to a merchant in response to a user purchasing goods or services from the merchant. A user may also direct the financial institution to deliver funds to a merchant by a certain date. There may be a time difference between the send date of the funds and the delivery date of the funds.

### SUMMARY

In some examples, a server system is disclosed that may include a processing unit and a computer-readable memory that may store computer-executable instructions that are executable by the processing unit to cause the computer server to perform various operations. The server system may transmit a command to a computing device to display an interactive calendar via a user interface of the computing device. The interactive calendar may include a month including a plurality of dates. The server system may receive a plurality of user-selected dates on the interactive calendar from a user interacting with the user interface. The server system may determine, using the plurality of user-selected dates, a fund delivery date. The server system may transmit the fund delivery date to the computing device for display on the interactive calendar via the user interface.

In other examples, a computing device can include a processing unit and a non-transitory computer-readable medium including instructions executable by the processing unit to cause the device to perform various operations. The device may receive a command from a server system to display an interactive calendar via a user interface of the computing device. The interactive calendar may include a month including a plurality of dates. The computing device may display the interactive calendar on the user interface. The computing device may receive a plurality of user-selected dates on the interactive calendar from a user interacting with the interactive calendar. The computing device may transmit the plurality of user-selected dates to the server system via a network. The computing device may receive a fund delivery date from the server system. The computing device may display the fund delivery date and the plurality of user-selected dates on the interactive calendar via the user interface.

In other examples, a method can include various operations. A command can be transmitted to a computing device to display an interactive calendar via a user interface of the computing device. The interactive calendar may include a month including a plurality of dates. A plurality of user-selected dates can be received from a user interacting with the user interface. A fund delivery date may be determined by a date selector using the plurality of user-selected dates. The fund delivery can be transmitted to the computing device for display on the interactive calendar via the user interface.

### BRIEF DESCRIPTION OF DRAWINGS

FIG. 1 is a block diagram of an example of a computing environment for determining fund delivery dates, according to one aspect of the present disclosure.

FIG. 2 is a block diagram of an example of a server system configured to execute programming code to determine a fund delivery date by a date selector, according to one aspect of the present disclosure.

FIG. 3 is a flowchart of an example of a process for determining and displaying a fund delivery date on an interactive calendar, according to one aspect of the present disclosure.

FIG. 4 is a schematic of an example of a user interface display of a computing device including an interactive calendar, according to one aspect of the present disclosure.

FIG. 5 is a schematic of another example of a user interface display of a computing device including an interactive calendar, according to one aspect of the present disclosure.

FIG. 6 is a schematic of another example of a user interface display of a computing device including an interactive calendar, according to one aspect of the present disclosure.

FIG. 7 is a schematic of another example of a user interface display of a computing device including an interactive calendar, according to one aspect of the present disclosure.

### DETAILED DESCRIPTION

Certain aspects and features relate to facilitating a date selector for an interactive calendar that allows users to determine fund delivery dates for financial transactions. A user may use the date selector to determine when to deliver funds from a user account in the financial institution to a destination, such as a merchant. The user may interact with the interactive calendar to view and select various dates, including a current date, due dates, send dates, fund delivery dates, and more. The various dates may be indicated on the calendar via symbols. The interactive calendar may include a legend for describing the symbols. After a user selects one or more dates, such as a due date or a send date, the date selector may use the selected dates to determine a fund delivery date. The fund delivery date may be the date that the funds are delivered to their destination.

The date selector and the interactive calendar may be executed by a server system of the financial institution. The server system may transmit the interactive calendar and the fund delivery dates determined by the date selector to a computing device operated by a user of the financial institution. In some examples, the server system may also include a backend server for storing and configuring financial account information. The financial account information may include the user's accounts and funds. In some examples, the backend server may be performing the fund delivery. The date selector may access the financial account information to help determine fund delivery dates.

In some examples, the interactive calendar may dynamically constrain the dates that are available to be selected by the user. For example, a user may be unable to select a send date on a date in the past. In another example, a user may be unable to select a send date that falls after a due date. In some examples, the date selector determining the fund delivery date based on the user-selected dates may include accounting for various factors that may delay fund delivery. The factors may include weekends or holidays where fund delivery may be unlikely or impossible, typical business days and hours of operation for merchants or other fund destinations, capability of the financial institution to send the funds, etc. In some examples where a user selects a send date for funds to be sent to a merchant and the date selector determines a fund delivery date that is after the due date, the interactive calendar may display a warning to the user that the funds may not be delivered before the due date.

In the following description, for the purposes of explanation, specific details are set forth in order to provide a thorough understanding of various implementations and examples. Various implementations may be practiced without these specific details. For example, circuits, systems, algorithms, structures, techniques, networks, processes, and other components may be shown as components in block diagram form in order not to obscure the implementations in unnecessary detail. The figures and description are not intended to be restrictive.

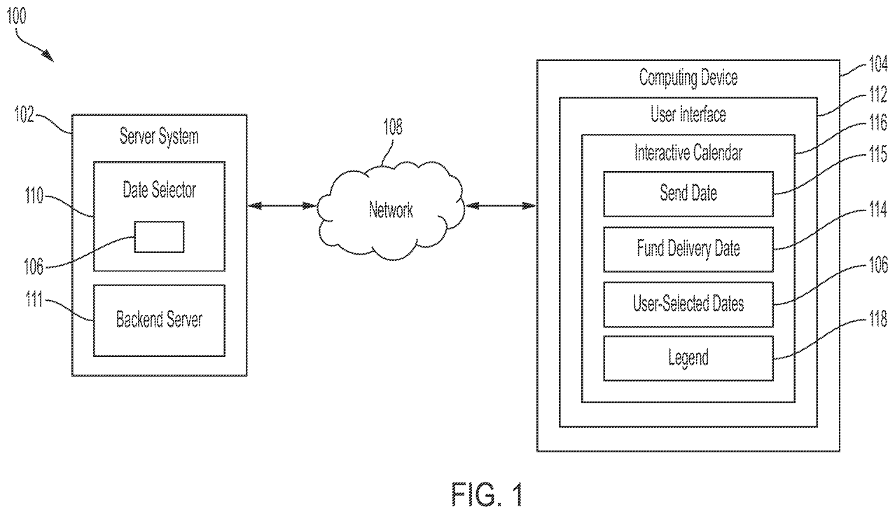

FIG. 1 is a block diagram of an example of a computing environment 100 for determining fund delivery dates 114, according to one aspect of the present disclosure. The computing environment 100 may include a server system 102, a computing device 104, and a network 108. In alternative configurations, different or additional components may be included in the computing environment 100.

The computing device 104 may be operated by a user of a financial institution, such as a bank. Examples of the computing device 104 include laptops, tablets, smart watches, smartphones, or other personal computing devices. The computing device 104 may receive resources related to the financial institution from the server system 102 over one or more networks 108. Examples of the network 108 may include a Local Area Network (“LAN”) or a Wide Area Network (WAN), as well as mobile telecommunication networks, short-range wireless networks, or various other communication network types (e.g., cable or satellite networks). The resources received from the server system 102 may include a web page to be displayed on a user interface 112 of the computing device 104. The user interface 112 may be an interactive display for displaying the resources to the user and allowing the user to interact with the resources.

The server system 102 may include a backend server 111 for storing and configuring financial accounts for users of the financial institution. In some examples, the resources (such as web pages) sent to the computing device 104 by the server system 102 may be generated and transmitted via the network 108 by the backend server 111. The server system 102 may include any type of server including, for example, a rack server, a tower server, a miniature server, a blade server, a mini rack server, a mobile server, an ultra-dense server, a super server, or the like. The server system 102 may include various hardware components, for example, a motherboard, a processing unit, memory systems, hard drives, network interfaces, power supplies, etc. The server system 102 may include one or more server farms, clusters, or any other appropriate arrangement or combination of computer servers. Additionally, server system 102 may act according to stored instructions located in a memory subsystem of the server system 102, and may execute an operating system or other applications.

The resources sent by the server system 102 to the computing device 104 may include an interactive calendar 116. The computing device 104 may display the interactive calendar 116 on its user interface 112. The interactive calendar 116 may include a particular month of a particular year, such as the current month. The interactive calendar 116 may include symbols on various dates of the month, such as due date symbols, fund delivery date symbols, user-selected date symbols, send date symbols, current date symbols, and more. The interactive calendar 116 may include a legend 118 with symbol descriptions. A user may interact with the user interface 112 to select one or more user-selected dates 106. In some examples, the user-selected dates 106 may be a send date for sending funds from a user account. In some examples, the legend 118 may include a log of one or more previous user-selected dates 106.

The computing device 104 may transmit the user-selected dates 106 to the server system 102. The date selector 110 in the server system 102 may receive the user-selected dates 106 and may determine one or more fund delivery dates 114 based on the user-selected dates 106. In some examples, the date selector 110 may use the user-selected dates 106 to determine one or more send dates 115. The one or more send dates 115 may be a date that funds can be sent to be delivered on or before the fund delivery date 114. In some examples, the date selector 110 may access information in the backend server 111, such as user account information, to determine the fund delivery date 114 and the send date 115. In some examples, the date selector 110 may be executed by the backend server 111.

After determining the fund delivery date 114, the server system 102 may transmit the fund delivery date 114 to the computing device 104 via the network 108. The computing device 104 may display the fund delivery date 114 on the month display of the interactive calendar 116 via the user interface 112. In some examples, the interactive calendar may also include visual indicators. Examples of the visual indicators may include a highlighting of the dates between a user-selected date 106 and a fund delivery date 114 to indicate the amount of time between sending funds and delivering funds to their destination.

In some examples, the interactive calendar 116 may include accessibility accommodations, such as a screen reader. The screen reader may output audio relating to the interactive calendar 116 via the user interface 112, including the month, year, dates with symbols, description of the symbols in the legend 118, and the visual indicators in the interactive calendar 116. The outputted audio may include any other information displayed in the interactive calendar 116.

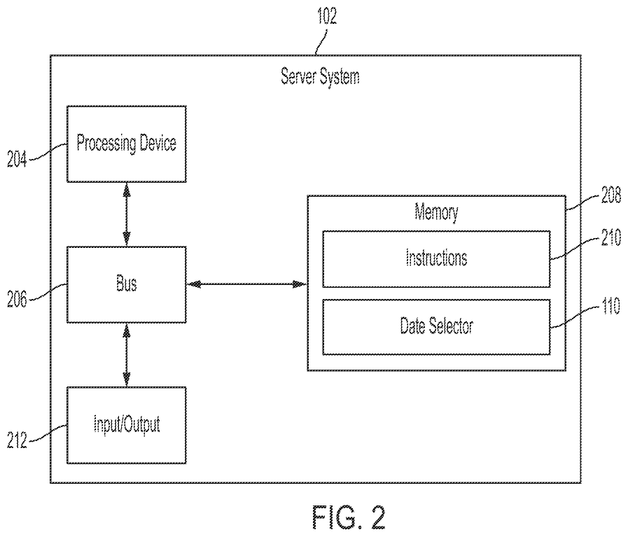

FIG. 2 is a block diagram of an example of a server system 102 configured to execute programming code to determine a fund delivery date by a date selector, according to one aspect of the present disclosure. The server system 102 may include a processing device 204, a bus 206, a memory 208, and an input/output device 212. In some examples, the components shown in the server system 102 may be integrated into a single structure. For example, the components can be within a single housing. In other examples, the components shown in FIG. 2 can be distributed (e.g., in separate housings) and in electrical communication with each other.

The processing device 204 may execute one or more operations for implementing various examples and embodiments described herein. The processing device 204 can execute instructions 210 stored in the memory 208 to perform operations. The processing device 204 can include one processing device or multiple processing devices. Non-limiting examples of the processing device 204 include a Field-Programmable Gate Array (“FPGA”), an application-specific integrated circuit (“ASIC”), a microprocessor, etc.

The processing device 204 may be communicatively coupled to the memory 208 via the bus 206. The non-volatile memory 208 may include any type of memory device that retains stored information when powered off. Non-limiting examples of the memory 208 include electrically erasable and programmable read-only memory (“EEPROM”), flash memory, or any other type of non-volatile memory. In some examples, at least some of the memory 208 may include a medium from which the processing device 204 may read instructions. A computer-readable medium may include electronic, optical, magnetic, or other storage devices capable of providing the processing device 204 with computer-readable instructions 210 or other program code. Non-limiting examples of a computer-readable medium include (but are not limited to) magnetic disk(s), memory chip(s), ROM, random-access memory (“RAM”), an ASIC, a configured processor, optical storage, or any other medium from which a computer processor may read instructions 210. The instructions 210 may include processor-specific instructions generated by a compiler or an interpreter from code written in any suitable computer-programming language, including, for example, C, C++, C#, etc.

The input/output device 212 may interface with other devices, such as the computing device 104, to analyze and receive information related to accessing functions of an application. Information received from the input/output device 212 may be sent to the memory 208 via the bus 206. For example, the computing device 104 may transmit user-selected dates 106 received through its user interface 112 from a user to the input/output device 212. The server system 102 may transmit fund delivery dates 114 determined by the date selector 110 to the computing device 104 via the input/output device 212. The memory 208 may store any information received through the input/output device 212.

The memory 208 may include program code for executing the date selector 110 for determining a fund delivery date 114 based on one or more user-selected dates 106 sent by the computing device 104. The memory 208 may access information relating to user accounts for the financial institution from the backend server 111. In some examples, the server system 102 may be or may include the backend server 111. The processing device 204 may execute instructions 210 in the memory to generate a web page including the interactive calendar 116 to be sent to the computing device 104 to be displayed on its user interface 112. The processing device 204 may generate and send updates to the interactive calendar 116 based on interactions a user has with the interactive calendar 116 on the user interface 112. For example, if a user selects a certain date on the interactive calendar 116, the processing device 204 may send an update to the interactive calendar 116 to display the selected date along with a corresponding symbol for the date.

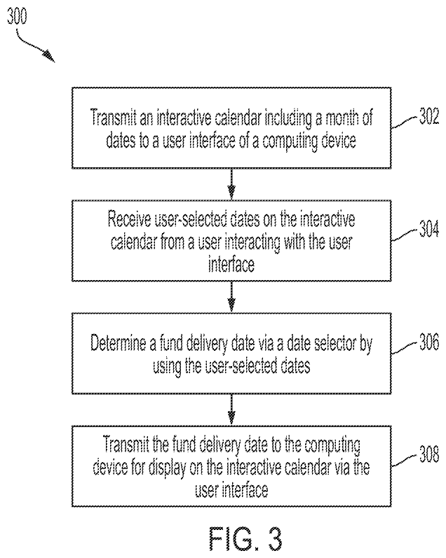

FIG. 3 is a flowchart of an example of a process 300 for determining and displaying a fund delivery date 114 on an interactive calendar, according to one aspect of the present disclosure. The process 300 is described in reference to FIGS. 1-2.

At block 302, a server system 102 transmits an interactive calendar 116 including a month of dates to be displayed on a user interface 112 of a computing device 104. The month may be the current month of the current year, with a symbol marking the current day. A previously selected due date with a corresponding symbol may also be displayed on the interactive calendar 116. The interactive calendar 116 may include a legend 118 displaying the symbols and their descriptions, such as the due date and the current day. The user may select one or more send dates for sending funds from their user account in a financial institution. The one or more send dates may be the user-selected dates 106. In some examples, the interactive calendar 116 may also include a text box. A user may interact with the user interface 112 to enter the user-selected dates 106 into the text box. The server system 102 may update the interactive calendar 116 to display the user-selected dates 106 inputted to the text box. Similarly, the server system 102 may update the text box to display text of the user-selected dates 106 after they are selected as dates on the month.

At block 304, the server system 102 receives the user-selected dates 106 on the interactive calendar 116 from the user interacting with the user interface 112. At block 306, the server system 102 may determine a fund delivery date 114 via a date selector 110 by using the user-selected dates 106 and a due date for the fund delivery. Determining the fund delivery date 114 may be based on a typical number of business days required for delivering funds. The date selector 110 may also base its determination on the size of the funds, whether the funds are electronically or physically delivered, the ability of the financial institution to deliver funds on certain days, etc.

In some examples, the user-selected date 106 may be a fund delivery date 114 rather than a send date. In response to receiving a fund delivery date 114, the server system 102 may determine a send date. That is, the server system 102 may work backwards to determine when funds should be sent in order to be delivered by the user-selected date 106. Determining the send date from a fund delivery date 114 may be determined similarly to determining a fund delivery date 114 from a user-selected date 106 that is a send date.

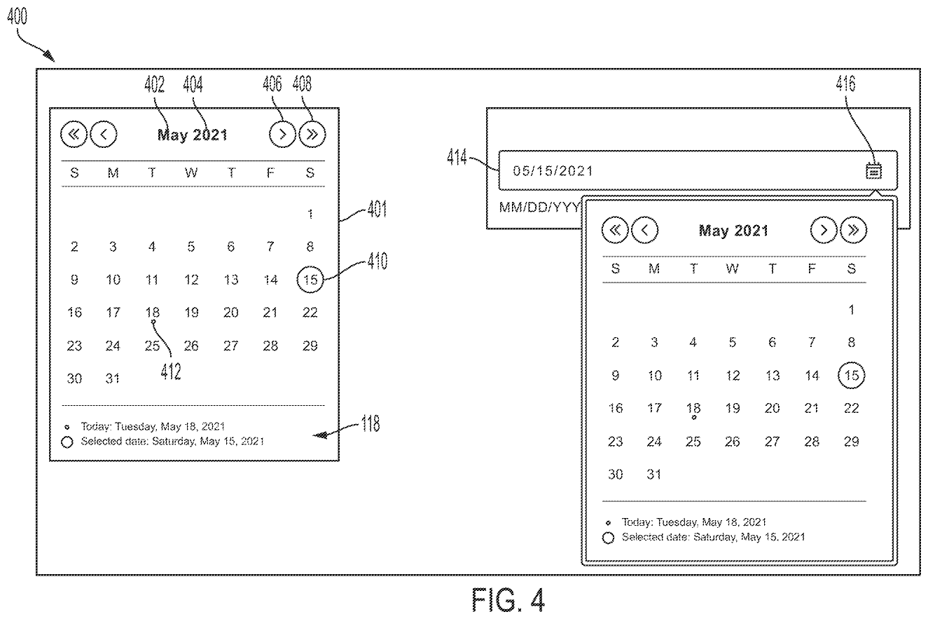

FIG. 4 is a schematic of an example of a user interface 112 display of a computing device 104 including an interactive calendar 400, according to one aspect of the present disclosure. The interactive calendar may include a month section 401 and a text box section 414. The month section 401 may display the month title 402 and year title 404 of the displayed month and year. The month section 401 may include single chevrons 406 and double chevrons 408. A user may interact with the user interface 112 to change the month or year by clicking on the single chevrons 406 or double chevrons 408, respectively. The current date may be marked on the month section 401 with a small dot symbol 412. The user may interact with the user interface 112 to input a user-selected date 106. In the example depicted in FIG. 4, the user-selected date 106 may be marked with a large circle symbol 410. After the user inputs the user-selected date 106, the server system 102 may update the interactive calendar 400 to display the large circle symbol 410.

The interactive calendar 400 includes a legend 118 below the month section 401. The legend depicts the small dot symbol 412 and the large circle symbol 410. The legend also includes a description for each symbol. For example, FIG. 4 depicts the small dot symbol 412 description of “Today: Tuesday, May 18, 2021” and the large circle symbol 410 description of “Selected date: Saturday, May 15, 2021.” If the dates with symbols change, for example due to the user selecting a different date, the server system 102 may update the legend 118 descriptions to match the changed dates. In some examples, the legend may include a log of previous user-selected dates 106 and previously determined fund delivery dates 114.

The text box section 414 may include a text version of the user-selected date 106. For example, FIG. 4 depicts the text box section 414 displaying “05/15/2021” to match the user-selected date 106 on the month section 401 marked with the large circle symbol 410. The server system 102 may update the text box section 414 according to user-selected dates 106 inputted to the month section 401. Alternatively, the user may input the user-selected date 106 into the text box, and the server system 102 may then update the month section 401 by displaying the large circle symbol 410 on the corresponding date. In some examples, the text box section 414 may include a month button 416. In response to the user clicking on the month button 416, the server system 102 may cause the user interface 112 to display another month section 401, including the symbols and legend 118, proximate to the text box section 414.

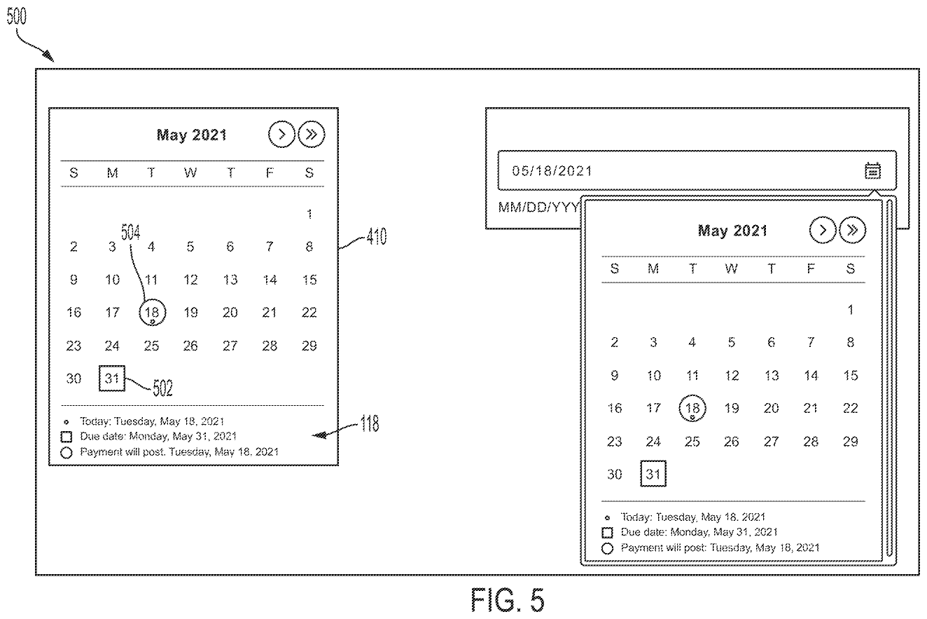

FIG. 5 is a schematic of another example of a user interface 112 display of a computing device 104 including an interactive calendar 500, according to one aspect of the present disclosure. The interactive calendar 500 may include similar components and functions as the interactive calendar 400 depicted in FIG. 4. Additionally, the interactive calendar 500 may include a square symbol 502 on a due date of the month section 401. The due date may be previously inputted by the user. Alternatively, the server system 102 may determine the due date by accessing information stored in the backend server 111. The legend 118 may also include the square symbol 502 and a description, in this example stating “Due date: Monday, May 31, 2021.” In FIG. 5, the interactive calendar 500 automatically includes a user-selected date 106 that is the current date. This may be used for same-day delivery of funds. The user may change the user-selected date 106 to a different date. If a different date is selected by the user, the legend 118 may be dynamically updated to reflect the changes. For example, if the user changes the user-selected date 106 to May 24, 2021, the large circle symbol 504 may display on May 24, 2021 rather than May 18, 2021. Additionally, the description in the legend for the large circle symbol 504 may automatically update to state “May 24, 2021.” The interactive calendar 500 may prevent the user from selecting dates on the month section 401 that precede the current date, along with weekends.

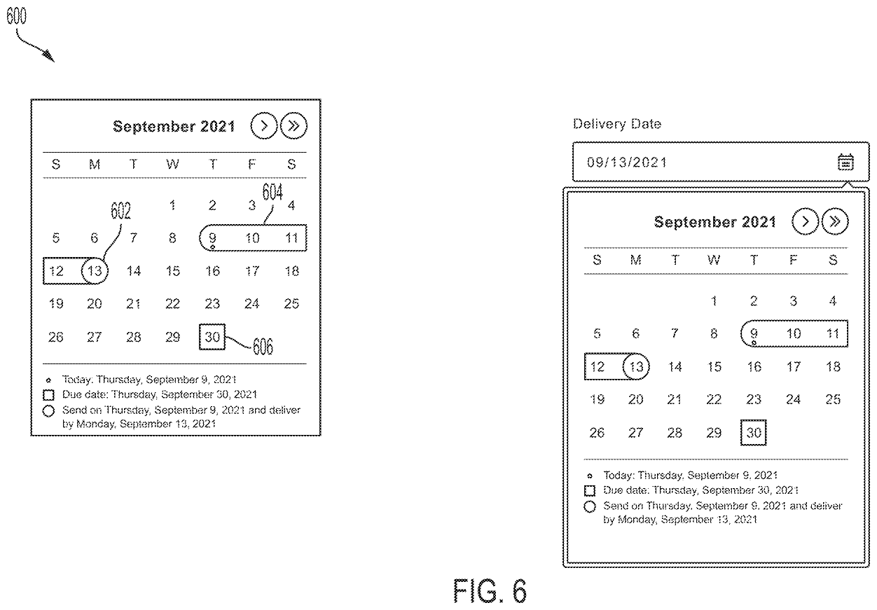

FIG. 6 is a schematic of another example of a user interface 112 display of a computing device 104 including an interactive calendar 600, according to one aspect of the present disclosure. The interactive calendar 600 may include similar components and functions as the interactive calendar 400 depicted in FIG. 4. Additionally in FIG. 6, the user-selected date 106 is the fund delivery date 114, marked with the square symbol 606. The server system 102 determines a send date 115 using the user-selected date 106 and sends an update to the interactive calendar 116 to display the send date 115, marked with the large circle symbol 602. The interactive calendar 600 also includes a visual indicator 604 that highlights the send date 115, fund delivery date 114, and one or more dates between them. Like the interactive calendar 500 displayed in FIG. 5, the interactive calendar 600 may prevent the user from selecting dates that precede the current date, along with weekends.

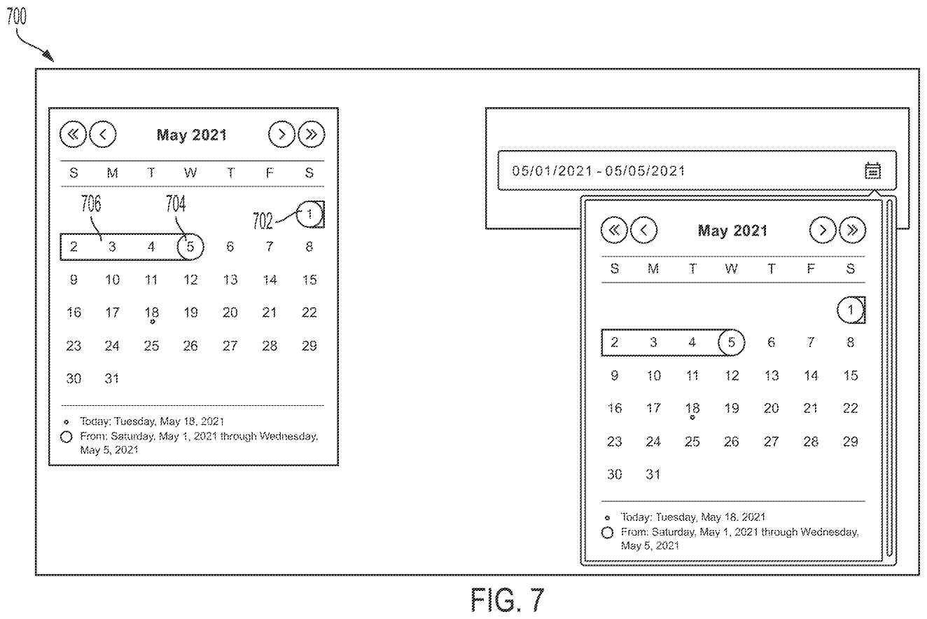

FIG. 7 is a schematic of another example of a user interface 112 display of a computing device 104 including an interactive calendar 700, according to one aspect of the present disclosure. The interactive calendar 700 may include similar components and functions as the interactive calendar 400 depicted in FIG. 4. Additionally, the interactive calendar 700 may include a first large circle symbol 702 and a second large circle symbol 704 to indicate a first and last date in a range of user-selected dates 106. For example, the user may select a range of user-selected dates 106 to send funds. In response to receiving a range of user-selected dates 106, the server system 102 may provide one or more fund delivery dates 114 to be displayed on the interactive calendar 700. The range of user-selected dates 106 may also include a visual indicator 706 highlighting the dates between the first and the last user-selected date 106.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A server system comprising:
a processing unit including one or more processing devices; and
a non-transitory computer-readable memory having instructions that are executable by the processing unit for causing the processing unit to:
transmit an interactive calendar to a computing device for display on a user interface of the computing device, the interactive calendar comprising a month including a plurality of dates;
receive, from a user interacting with the user interface, a plurality of user-selected dates on the interactive calendar;
determine, via a date selector and using the plurality of user-selected date, a fund delivery date; and
transmit the fund delivery date to the computing device for display on the interactive calendar via the user interface.

2. The server system of claim 1, wherein the interactive calendar further comprises:
a month title for displaying a month and a year shown in the interactive calendar;
a plurality of single chevrons for selecting the month shown in the interactive calendar;
a plurality of double chevrons for selecting the year shown in the interactive calendar;
a legend for displaying a plurality of symbols and a plurality of symbol descriptions, the plurality of symbols being displayed on a plurality of dates in the interactive calendar, wherein the legend is dynamically changeable in response to user input; and
a first circle displayed on a first user-selected date of the plurality of user-selected dates in the interactive calendar and a second circle displayed on a second user-selected date of the plurality of user-selected dates in the interactive calendar, wherein one or more dates between the first user-selected date and the second user-selected date are highlighted.

3. The server system of claim 2, wherein the plurality of symbols comprises a current date symbol, a due date symbol, and a fund delivery date symbol.

4. The server system of claim 2, wherein the interactive calendar further comprises a screen reader for outputting audio via the user interface, the audio representing information on the user interface comprising:
the month shown in the interactive calendar;
the year shown in the interactive calendar;
the plurality of symbols being displayed on the plurality of dates in the interactive calendar; and
the plurality of symbol descriptions in the legend.

5. The server system of claim 2, wherein the interactive calendar further comprises a text box for receiving and displaying an input of a plurality of user-selected dates from the computing device, and wherein the server system determines and transmits a change to the plurality of user-selected dates displayed in the text box based on a change to the plurality of user-selected dates inputted to the interactive calendar to the computing device.

6. The server system of claim 1, wherein the server system is a financial institution server system for allowing a user to conduct transactions with a financial institution via the computing device.

7. The server system of claim 1, wherein the server system further comprises a backend server including financial account information, wherein the server system accesses the financial account information to determine the fund delivery date and a fund send date, wherein a transaction sent on the fund send date is delivered on the fund delivery date.

8. A computing device comprising:
a processing unit including one or more processing devices; and
a non-transitory computer-readable memory comprising instructions that are executable by the processing unit to cause the computing device to:
receive an interactive calendar from a server system for display on a user interface of the computing device, the interactive calendar comprising a month including a plurality of dates;
display, via the user interface, the interactive calendar;
receive, from a user interacting with the user interface, a plurality of user-selected dates on the interactive calendar;
transmit the plurality of user-selected dates to the server system via a network;
receive a fund delivery date from the server system; and
display the fund delivery date and the plurality of user-selected dates on the interactive calendar via the user interface.

9. The computing device of claim 8, wherein the interactive calendar further comprises:
a month title for displaying a month and a year shown in the interactive calendar;
a plurality of single chevrons for selecting the month shown in the interactive calendar;
a plurality of double chevrons for selecting the year shown in the interactive calendar;
a legend for displaying a plurality of symbols and a plurality of symbol descriptions, the plurality of symbols being displayed on a plurality of dates in the interactive calendar, wherein the legend is dynamically changeable in response to user input; and
a first circle displayed on a first user-selected date of the plurality of user-selected dates in the interactive calendar and a second circle displayed on a second user-selected date of the plurality of user-selected dates in the interactive calendar, wherein one or more dates between the first user-selected date and the second user-selected date are highlighted.

10. The computing device of claim 9, wherein the plurality of symbols comprises a current date symbol, a due date symbol, and a fund delivery date symbol.

11. The computing device of claim 9, wherein the interactive calendar further comprises a screen reader for outputting audio via the user interface, the audio representing information on the user interface comprising:
the month shown in the interactive calendar;
the year shown in the interactive calendar;
the plurality of symbols being displayed on the plurality of dates in the interactive calendar; and
the plurality of symbol descriptions in the legend.

12. The computing device of claim 9, wherein the interactive calendar further comprises a text box for receiving and displaying an input of a plurality of user-selected dates from the computing device, and wherein the computing device receives and displays a change to the plurality of user-selected dates displayed in the text box based on a change to the plurality of user-selected dates inputted to the interactive calendar.

13. The computing device of claim 8, wherein the server system is a financial institution server system for allowing a user to conduct transactions with a financial institution via the computing device.

14. The computing device of claim 8, wherein the server system further comprises a backend server including financial account information, wherein the server system accesses the financial account information to determine the fund delivery date and a fund send date, wherein a transaction sent on the fund send date is delivered on the fund delivery date.

15. A method comprising:
transmitting an interactive calendar to a computing device for display on a user interface of the computing device, the interactive calendar including a month including a plurality of dates;
receiving, from a user interacting with the user interface, a plurality of user-selected dates on the interactive calendar;
determining, by a date selector and using the plurality of user-selected date, a fund delivery date; and
transmitting the fund delivery date to the computing device for display on the interactive calendar via the user interface.

16. The method of claim 15, wherein the interactive calendar further includes:
a month title for displaying a month and a year shown in the interactive calendar;
a plurality of single chevrons for selecting the month shown in the interactive calendar;
a plurality of double chevrons for selecting the year shown in the interactive calendar;
a legend for displaying a plurality of symbols and a plurality of symbol descriptions, the plurality of symbols being displayed on a plurality of dates in the interactive calendar, wherein the legend is dynamically changeable in response to user input; and
a first circle displayed on a first user-selected date of the plurality of user-selected dates in the interactive calendar and a second circle displayed on a second user-selected date of the plurality of user-selected dates in the interactive calendar, wherein one or more dates between the first user-selected date and the second user-selected date are highlighted.

17. The method of claim 16, wherein the plurality of symbols includes a current date symbol, a due date symbol, and a fund delivery date symbol.

18. The method of claim 16, wherein the interactive calendar further includes a screen reader for outputting audio via the user interface, the audio representing information on the user interface comprising:
the month shown in the interactive calendar;
the year shown in the interactive calendar;
the plurality of symbols being displayed on the plurality of dates in the interactive calendar; and
the plurality of symbol descriptions in the legend.

19. The method of claim 16, wherein the interactive calendar further includes a text box for receiving and displaying an input of a plurality of user-selected dates from the computing device, wherein the method further comprises determining and transmitting a change to the plurality of user-selected dates displayed in the text box based on a change to the plurality of user-selected dates inputted to the interactive calendar to the computing device.

20. The method of claim 15, further comprising:
determining the fund delivery date by accessing financial account information stored in a backend server; and
determining a fund send date, wherein a transaction sent on the fund send date is delivered on the fund delivery date.
